(19) United States
(12) Patent Application Publication
(10) Pub. No.: US 2005/0238780 A1
(43) Pub. Date: Oct. 27, 2005

(54) Rolled dough compositions and related methods and products

(75) Inventors: Penny L. Norquist, St. Paul, MN (US); Katherine E. Shriver, New Brighton, MN (US); Daniel J. Wendt, Lion Lakes, MN (US)

Correspondence Address: GENERAL MILLS, INC., P.O. BOX 1113, MINNEAPOLIS, MN, 55440, US

(73) Assignee: General Mills Marketing, Inc.

(21) Appl. No.: 11/104,702

(22) Filed: Apr. 13, 2005

Related U.S. Application Data
(60) Provisional application No. 60/561,629, filed on Apr. 13, 2004.

(51) Int. Cl. A21D 10/00

(52) U.S. Cl. 426/549

(57) ABSTRACT

Described are refrigerated, rolled dough compositions that do not require a slip liner between contacting surfaces of the dough composition, e.g., that include rice flour between contacting surfaces.

This application claims the benefit of priority under 35 U.S.C. 119(e)(1) of a provisional patent application, Ser. No. 60/561,629, filed Apr. 13, 2004, which is incorporated herein by reference in its entirety.

### FIELD OF THE INVENTION

The invention relates to refrigerated and frozen, rolled dough compositions, e.g., pie crusts, that include rice flour as an anti-stick agent to prevent sticking after periods of refrigerated or frozen storage, without the need for a slip liner.

### BACKGROUND

Consumers enjoy the convenience of refrigerated, ready-to-use (i.e., ready-to-bake) doughs such as refrigerated, ready-to use pie crusts. Such products are commercially available in the form of rolled-up pie crusts that include a slip liner to prevent the dough from sticking to itself, and also as folded crusts. Similar products are available in frozen form.

### SUMMARY

The invention relates to the use of rice flour to prevent sticking between surfaces of rolled-up (rolled) dough compositions, e.g., refrigerated or frozen rolled-up pie crusts. A “rolled” or “rolled-up” dough composition refers to a sheeted dough that has been continuously rolled over itself starting at one edge and continuing substantially or completely to the other edge, to form a cross-section that takes the form of a spiral, as differentiated from a dough composition that is merely folded once or multiple times.

Some commercial, refrigerated, pie crust dough products are folded into half and then quarters, with a rice powder coated between contacting surfaces. With folding in half and then quarters, the pie crust must be coated on both sides.

Commercial rolled-up pie crust products include a slip liner to prevent dough surfaces from sticking together. The slip liner is typically a paper or plastic sheet placed between the rolled layers of dough to prevent their contact. The slip liner can add substantial expense to a dough product due to the cost of the liner, as well as the added steps and complication associated with including the liner in a commercial product, which can add expensive manufacturing steps, complication, and can reduce yield.

The invention recognizes that a slip liner can be eliminated from a refrigerated or frozen rolled-up dough composition by using rice flour between rolled layers of the dough composition. Eliminating the need for a slip liner reduces the cost of a dough product by the difference between a slip liner and the less expensive rice flour. In terms of efficiency and yield, the replacement of a slip liner with rice flour further reduces product cost by replacing the complicated process steps of inserting a film liner between layers of a dough product—involving, e.g., cutting and proper placement—with a powder coating step. Yield is improved and overall cost is reduced.

According to various embodiments of the invention, a dough composition can be prepared based on any useful dough formulation, such as a formulation useful to prepare a pie crust dough composition. The dough composition can be prepared by combining ingredients as desired, and then further processed by steps including sheeting. A sheeted dough composition can be processed, cut, and shaped as desired, e.g., as a square, rectangle, circle or oval, triangle, etc. A coating of rice flour can be applied to one or both surfaces of a sheeted dough composition, in a total amount effective to allow unrolling after refrigerated or frozen storage, and the dough composition can be rolled up onto itself. Optionally, prior to, during, or after a rolling step, water can be applied between the surfaces of the dough composition at the outer rolled edge—this is the edge associated with the last (outer) layer of rolled dough (the outer rolled edge). The water can increase the tackiness and adhesion between these dough surfaces and can inhibit or prevent unrolling of the outer layer edge during subsequent processing, for example between the end of the rolling step and the beginning of a packaging step.

According to embodiments of the invention, a rolled dough product that contains rice flour between contacting surfaces can be stored at refrigerated conditions, such as from 32 to 45 degrees Fahrenheit, often a temperature in the range from 40 to 45 degrees Fahrenheit, for a period of weeks or months, and can still be unrolled by hand, without damaging (e.g., tearing) the dough. Exemplary doughs of the invention can have a shelf life at refrigerated conditions of at least about 30 to 90 days, or even greater than 90 days. Embodiments of the invention can also be stored frozen (e.g., at −10F. to 10F.), and can have a frozen shelf life of at least 5 months or even greater than 7 months, followed by a refrigerated shelf life of 90 days. During such refrigerated or frozen storage, a dough can be unrolled without producing substantial damage to the dough composition, meaning that the dough composition can be unrolled (optionally after thawing a frozen dough composition) without causing the dough to tear or crack. The dough composition can then be formed into a dough product such as a pie crust, and cooked (e.g., baked), to produce a high quality cooked food product that exhibits expected organoleptic properties including taste, color (browning), flakiness if desired, and leavening if desired.

An aspect of the invention relates to a rolled-up dough composition that includes rice flour between contacting surfaces, wherein the dough composition is capable of being unrolled following 30 or 90 days of refrigerated storage.

In another aspect, the invention relates to a method of preventing contacting surfaces of a refrigerated, rolled-up dough composition from sticking together. The method includes disposing rice flour between contacting surfaces of the rolled-up dough composition.

In another aspect, the invention relates to a dough product that includes a rolled-up dough composition in a tube package, wherein the dough composition does not contain a sheet between layers of the rolled dough.

### DETAILED DESCRIPTION

Examples of dough formulations for use according to this description can be dough compositions that are adapted for refrigerated or frozen storage while rolled up without a slip liner or other form of plastic or paper sheet inserted between dough surfaces. Certain embodiments of such rolled-up dough compositions are capable of being removed from refrigerated or frozen storage and used to produce a farinaceous food product, e.g., by unrolling and then by steps that include one or more of cutting, forming, shaping, and combining a dough with other ingredients, as is appropriate for a given type of dough. Certain details of the following description are directed to pie crust doughs. It is to be understood, however, that food and dough products other than pie crusts, such as pizza crusts, puff pastry, tortillas, cookie doughs, and other dough compositions that may be formed into a rolled-up sheet, can be produced similarly.

A dough composition can broadly include ingredients known to be useful for producing sheeted or sheeted and rolled-up dough products. These can include flour, starch, shortening (e.g., solid fat), water, salt, and gluten (optional). Other ingredients for various dough compositions may include yeast or a chemical leavening agent, as desired; particulates; or added flavorings and preservatives.

According to an embodiment of a dough composition in the form of a pie crust, a blend of dry flour and starch can be included in a range from about 38 to about 58 percent by weigh of dry flour and starch blend, based on the total weight of the dough composition. In other embodiments, a blend of dry flour and starch can be used in an amount from about 50 to about 53 percent by weight, based on the total weight of the dough composition.

The blend of flour and starch may contain useful relative amounts of flour and starch. According to certain embodiments, the blend can contain up to 65 percent by weight starch based on the total amount of flour and starch. In other embodiments, the blend can contain from 45 to 60 weight percent starch or from 50 to 55 weight percent starch, based on the total weight of starch and flour.

Useful types of starch will be understood by those of skill, and include, for example, corn starch, wheat starch, tapioca starch, and the like.

Shortening or lard (liquid or solid fat) is included in many dough formulations, and can be useful in pie crust doughs at a relatively high level, to give desired texture to baked pie crust. An amount of shortening for a pie crust dough can be in the range of between about 24 and about 35 weight percent, based on the total weight of the dough. Shortening or lard may also be used in an amount in the range from about 26 weight percent and about 34 weight percent, e.g., from about 28 weight percent and 32 weight percent, based on the total weight of the dough composition. One of skill will understand that many types of shortening or lard may be useful. Certain useful shortenings can have a solid fat index at 50 degrees Fahrenheit in the range from about 25 to 36 (e.g., from 25.5 to 28), and a Wiley melting point of at least 108 to 118 degrees Fahrenheit (e.g., 108.5 to 112 degrees Fahrenheit).

Water can be present in a dough composition in a desired amount. Water may be introduced into a dough generally by at least two means: ingredients (e.g., flour) can contain an amount of water, and water may normally be added to the dough as a separate ingredient. The total amount of water in a dough composition can vary depending on the type of dough. For a pie crust dough, water can be present in a range from about 19 and about 25 percent by weight based on total weight of dough composition. In other embodiments of pie crust doughs, water may be present in a range from about 20 weight percent to about 24 weight percent based on the total weight of the dough composition, e.g., from about 21 weight percent to about 23 weight percent based on the total weight of the dough composition.

Salt can be included in a dough composition in a useful amount. In exemplary pie dough compositions, salt can be included in an amount from about 0 to 3 weight percent, based on the total weight of the dough composition, e.g., for flavor purposes and also to reduce water activity.

Dough compositions according to embodiments of the invention can be prepared by useful, conventional or future-developed, methods and techniques, including steps such as mixing or blending ingredients, sheeting, folding, lapping, cutting, and rolling.

According to one embodiment of the invention, a pie crust dough can be prepared as follows. Shortening, either in liquid form or solid form, can be added to a chilled blend of flour and starch. The ingredients can be mixed to disperse the shortening, flour, and starch. Either during or after the shortening addition, water can be added with additional mixing to disperse the water within the mixture and to hydrate and develop gluten of the flour. Other ingredients, such as salt, preservatives and color, can be added with the water.

As will be understood by those of skill in the dough and baking arts, properties of an unbaked and baked pie crust can be affected not only by the ingredients and their amounts in a dough, but also by factors such as the timing, temperature, and form of ingredients added to prepare the dough. One of skill will be able to select and control such factors to obtain a desirable baked crust.

Once produced, a pie crust dough can be further processed as desired, such as by sheeting with any suitable sheeting apparatus. During the sheeting operation, a dough may be at a temperature to prevent damage, e.g., at least about 55 degrees Fahrenheit to prevent disruption of the continuous sheet, and a temperature that does not exceed about 75F. Also during sheeting, if desired, the dough surface can be dusted with an anti-sticking material such as the blend of flour and starch, to prevent sticking of the dough surface to rolls of the sheeting apparatus.

According to the invention, rice flour can be applied to one or both surfaces of a dough composition to reduce or prevent surfaces of the dough from sticking together when the dough composition is rolled up and stored at a refrigerated or frozen temperature. Exemplary rice flour compositions that may be useful are commercially available. Rice flour compositions can be prepared to have various particle sizes, as measured by different particle size features, and may include rice flour powders having a mean or midpoint particle diameter in the range from 25 microns to 270 microns, e.g., from 50 microns to 200 microns.

As is understood, particles of a mass of powder such as rice flour do not normally have a uniform size, but have a particle size distribution that is typically of approximately a bell-curve profile. Other specifics of this type of size profile, besides average diameter, can also be considered with respect to the effectiveness of a rice flour in preventing sticking between refrigerated dough surfaces. For example, while not required, certain useful rice flour compositions for use according to the invention may exhibit any one or more of a mean particle diameter in the range from 25 microns to 270 microns, e.g., from 50 microns to 200 microns; a diameter of 90 percent by volume of the powder particles of less than 300 microns, e.g., less than 250 microns; and a diameter of at least 90 percent by volume of the powder particles of greater than 10 microns, e.g., greater than 15 microns.

In general, a rice flour used in accordance with the invention be available as having a moisture content in the range about 12 percent by weight, e.g., from 8 to 14 percent by weight, although higher and lower amounts are can also be useful.

Rice flour as described herein can be applied to a dough composition surface by any useful method. By one method, rice flour can be dusted onto a surface of a dough composition that has already been prepared from its basic ingredients, and that has been partially or fully formed into a dough product or dough product portion, (e.g., sheeted and optionally cut or otherwise shaped). According to this method, a dough composition can be prepared by mixing its ingredients together and processing, e.g., including a sheeting, rolling, and/or cutting step, as would be done with a pie crust product. After sheeting, and before or after cutting, rice flour can be placed at one or both surfaces of the dough composition.

Application of rice flour onto one or both of the surfaces of a dough composition can be accomplished by any useful method, such as by spraying, dusting, or brushing rice flour onto a surface. Rice flour can be applied to a surface of a dough composition by itself or in combination with one or more other dry or liquid materials, such as water or oil, to prevent large amounts of rice flour dust from escaping the immediate area of application.

The amount of rice flour applied to a dough composition can be an amount that will reduce the tendency of dough surfaces to stick together when the dough is rolled-up onto itself e.g., an amount that will allow the dough to be unrolled after refrigerated storage, without substantial damage (e.g., tearing, cracking, etc.) to the dough composition, e.g., after as much as 30 to 90 days, or in excess of 90 days, of refrigerated storage at 45 degrees Fahrenheit. Alternately, an amount of rice flour can be applied to allow the dough to be unrolled after frozen storage, upon thawing, without substantial damage (e.g., tearing, cracking, etc.) to the dough composition, e.g., after 5 or after 7 or more months of frozen storage at a temperature in the range from −10 to +10 degrees Fahrenheit.

As specific exemplary amounts, rice flour (e.g., containing approximately 12 weight percent moisture and no oil carrier) can be applied to a single surface of a dough that will be rolled up, in an amount in the range from 0.1 to about 2 weight percent, based on the total weight of the dough, for a dough composition having a thickness in the range from 1/16 of an inch up to ⅜ of an inch. In certain embodiments, rice flour can be applied in to a single surface of a pie dough in an amount in the range from 0.3 to 1.5 weight percent rice flour, based on the total weight of the dough composition. Also according to certain embodiments, a circular pie crust having a thickness in the range from 1/16 of an inch to ⅜ of an inch, (typically about ⅛ inch) may be coated on one or both surfaces with rice flour in a total amount of from 0.3 to 0.7 weight percent rice flour, e.g., about 0.5 weight percent rice flour, based on the weight of the pie crust dough. Stated in other terms, a useful amount of rice flour applied to a single surface of a circular sheeted pie crust dough, may be in the range from 0.001 to 0.3 grams rice flour per square inch of dough composition (for full coverage), e.g., 0.01 to 0.1 grams rice flour per square inch (full coverage), for a circular pie crust that has a thickness of, e.g., ⅛ of an inch and a diameter of 11.5 inches.

In embodiments of applying a dry rice flour to a dough surface, a dough composition surface may be treated to improve adhesion of the dry rice flour powder to the dough surface, such as by application of a liquid to the dough surface prior to application of rice flour. As an example, a light coating of water, fat, or oil, may be first applied to a dough surface by spraying, sprinkling, misting, or brushing, and then a rice flour powder can be applied by dusting or any other useful method.

In certain alternate embodiments, rice flour can be applied as a combination containing rice flour powder with a small amount of liquid to prevent dusting, such as water or a liquid oil or fat or another edible organic liquid. In this embodiment, oil can be present in the rice flour powder as a processing aid for the flour, and is often present in the flour from the flour's supplier. A liquid oil or fat can be particularly useful with lower range rice flour particles, to avoid or prevent dusting that can be associated with processing these smaller sized particles.

The liquid oil or fat can be a room temperature liquid fat or oil or a (melted) room temperature solid shortening, shortening chip, or fat, many examples of which are well known and commercially available within the cooking and baking arts. Specific examples of room temperature liquid or room temperature solid oils include liquid vegetable oils, corn oil, soy oil, peanut oil, coconut oil, palm oil, and the like; liquid or solid vegetable or animal shortening; and glycerin or other such low molecular weight polyols. If a liquid oil or fat is used with the rice flour applied to a dough surface, the relative amounts of rice flour and liquid fat or oil can be amounts that allow placement of a useful amount of rice flour onto a dough composition surface, i.e., an amount that can reduce or prevent sticking of dough surfaces during refrigerated or frozen storage. Specific relative amounts of rice flour and oil can depend on factors such as the type of oil, the type of dough or dough surface, the type and amount of rice flour, the size profile of the rice flour, etc., as will be appreciated and understood by one of skill.

The dough can be cut and rolled, by useful, conventional, or future-developed methods, e.g., by hand, or by use of automated equipment. An automated process, for example, has been described in Assignee's U.S. Pat. No. 6,838,105 entitled “Dough Product Rolling Apparatus and Method for Rolling Dough Products.”

According to embodiments of the invention, water may be applied to one or more surfaces of the dough composition to provide a desired degree of tackiness at the outer rolled edge, to inhibit or prevent unrolling of that edge of the rolled product. For instance, water may be applied to the outer rolled edge, either before, during, or after the rolling step, and prior to a subsequent processing step such as a packaging step. The water may be applied in an amount that is useful to prevent unrolling, which may be a light application of water applied at the inside surface proximal to the outer rolled edge (not over the entire dough surface). The water may be applied by any useful method, such as by brushing, sprinkling, spraying, etc.

According to certain embodiments of the invention, no separating sheet of any form, e.g., parchment, slip sheet, coated or uncoated paper or polymeric material etc., is placed between surfaces of the dough composition.

The rolled-up dough composition can be packaged in a desired package, such as a tube package that is of a shape that approximates the shape of the rolled-up dough composition. The package may include plastic, paper, or polymeric materials, such as a paper or cardboard box, or a plastic box that contains one or multiple rolled-up dough compositions. One example of a useful package type can be a tube- or sleeve-like package in the form of a rigid or flexible, elongate, cylindrical body that can contain one or multiple rolled-up dough compositions. According to a more specific example, the package can include a flexible tube- or sleeve-like body having two closed (e.g., sealed) ends. A flexible body may be of any useful or desired shape, including a cross-section that is square, angular, rounded, circular, oval, rectangular, triangle, etc. A flexible body may be formed from any flexible material useful for packaging, such as a coated or uncoated polymeric or paper material, and may have barrier properties to one or more of oxygen, carbon dioxide, or moisture, to allow a refrigerated or frozen dough composition to retain freshness and exhibit storage stability and a desired shelf life. Optionally, a package that includes a flexible outer body can include a more stiff or rigid material such as a cardboard or plastic tray, inside the flexible wrapper, to support a dough composition.

The package, e.g., a flexible sleeve, may be formed by any useful method, as will be appreciated, and as is appropriate for a specific package type. A plastic or cardboard box can be prepared by injection molding or cutting and folding.

A flexible sleeve package can be prepared, for example, by rolling or folding a sheet of flexible material and bonding contacting edges by a bonding method that may include one or more of folding, heat sealing, application of a food-quality adhesive, or combinations of these or other sealing techniques. The rolled-up dough composition can be inserted into the body and the ends of the rolled flexible packaging material can be sealed by one or more of folding, heat sealing, application of an adhesive, or any other sealing method.

It is to be understood that while there have been illustrated and described certain forms of the present invention, the invention is not to be limited to the specific form disclosed herein except to the extent that such limitations are found in the appended claims. Other embodiments of this invention will be apparent to those skilled in the art upon consideration of this specification or from practice of the invention disclosed herein. Various omissions, modifications, combinations, and changes to the principles and embodiments described herein may be made by one of skill in the relevant arts, without departing from the scope and spirit of the invention.

### EXAMPLES

### Example 1

Examples of particle size distributions of rice flours that are useful according to the invention, include the following, as measured using a Microtrac particle size analyzer Model No. S3500, using isopropyl alcohol.

Sample 1

| | | |
|---|---|---|
| Mean Diameter (MV) | 149 | Microns |
| Calc Surface Area (CS) | 0.119 | meters²/cc |
| 10th Percentile Diameter | 28.0 | Microns |
| 50th Percentile Diameter | 150 | Microns |
| 90th Percentile Diameter | 270 | Microns |

Sample 2

| | | |
|---|---|---|
| Mean Diameter (MV) | 73.4 | Microns |
| Calc Surface Area (CS) | 0.231 | meters²/cc |
| 10th Percentile Diameter | 11.7 | Microns |
| 50th Percentile Diameter | 68.1 | Microns |
| 90th Percentile Diameter | 140 | Microns |

### Example 2

Pie crusts were prepared and rolled using various non-stick surface agents, including rice flour and various backings at the rolled surface. The rolled crusts were wrapped and sealed in flexible film “over-wrap” packages. The flexible films were packaging films having different degrees of moisture and oxygen barrier properties.

The rice flour was applied at a level of 0.05-0.1% by weight of the product.

The packaged, rolled crusts were stored for different periods of refrigerated and frozen storage, removed from storage, removed from the packaging, and unrolled after periods of 0, 5, 10, and 15 minutes at room temperature.

Materials and Methods

TEST 1

| Backing | Film Type |
|---|---|
| Blue Film (LDPE/LLDPE) (BF) | Control (C) |
| Rice Flour (RF) | High Oxygen (HL) |
| Saran Wrap (SW) | High Moisture (HM) |
| Parchment (P) | |
| Fruit-Roll Up Backing (FR) | |

Observations & Data
Level of Cracking Scale: 1-10
1=none
5=small crack all the way through dough
10=large cracks greater than 3″ in length

Day 15—Frozen

| | | | Level of |
|---|---|---|---|
| BACKING- | Time to | Cracking | Cracking |
| FILM | Unroll | Y/N | 1-10 |
| BF-C | 0 | N | |
| | 5 | Y | 2 |
| | 10 | N | |
| | 15 | N | |
| BF-HO | 0 | N | |
| | 5 | N | |
| | 10 | N | |
| | 15 | N | |
| BF-HM | 0 | N | |
| | 5 | Y | 1 |
| | 10 | Y | 2 |
| | 15 | Y | 2 |
| RF-C | 0 | N | |
| | 5 | N | |
| | 10 | N | |
| | 15 | N | |
| RF-HO | 0 | N | |
| | 5 | N | |
| | 10 | N | |
| | 15 | N | |
| RF-HM | 0 | Y | 3 |
| | 5 | N | |
| | 10 | N | |
| | 15 | N | |
| P-C | 0 | Y | 8 |
| | 5 | N | |
| | 10 | N | |
| | 15 | N | |
| SW-C | 0 | N | |
| | 5 | N | |
| | 10 | N | |
| | 15 | N | |
| SW-HM | 0 | N | |
| | 5 | N | |
| | 10 | Y | 1 |
| | 15 | N | |

Day 15—Refrigerated

| | | | Level of |
|---|---|---|---|
| BACKING- | Time to | Cracking | Cracking |
| FILM | Unroll | Y/N | 1-10 |
| BF-C | 0 | N | |
| | 5 | N | |
| | 10 | N | |
| | 15 | N | |
| BF-HO | 0 | N | |
| | 5 | N | |
| | 10 | N | |
| | 15 | N | |
| BF-HM | 0 | Y | 4 |
| | 5 | Y | 1 |
| | 10 | Y | 2 |
| | 15 | Y | 6 |
| RF-C | 0 | N | |
| | 5 | N | |
| | 10 | N | |
| | 15 | N | |
| RF-HO | 0 | N | |
| | 5 | N | |
| | 10 | N | |
| | 15 | N | |
| RF-HM | 0 | N | |
| | 5 | N | |
| | 10 | N | |
| | 15 | Y | 1- |
| | | | BOTTOM |
| P-C | 0 | Y | 4 |
| | 5 | N | |
| | 10 | Y | 4-MANY |
| | 15 | Y | 3-MANY |
| SW-C | 0 | N | |
| | 5 | N | |
| | 10 | N | |
| | 15 | N | |
| SW-HM | 0 | N | |
| | 5 | Y | 1-top and |
| | | | bottom |
| | 10 | N | |
| | 15 | N | |

Day 30—Refrigerated

| | | | Level of |
|---|---|---|---|
| BACKING- | Time to | Cracking | Cracking |
| FILM | Unroll | Y/N | 1-10 |
| BF-C | 0 | N | |
| | 5 | N | |
| | 10 | N | |
| | 15 | N | |
| BF-HO | 0 | N | |
| | 5 | N | |
| | 10 | N | |
| | 15 | N | |
| BF-HM | 0 | Y | 2 |
| | 5 | N | |
| | 10 | N | |
| | 15 | Y | 2 |
| RF-C | 0 | N | |
| | 5 | N | |
| | 10 | N | |
| | 15 | N | |
| RF-HO | 0 | N | |
| | 5 | N | |
| | 10 | N | |
| | 15 | N | |
| RF-HM | 0 | N | |
| | 5 | N | |
| | 10 | N | |
| | 15 | N | |

Day 60—Refrigerated

| | | | Level of |
|---|---|---|---|
| BACKING- | Time to | Cracking | Cracking |
| FILM | Unroll | Y/N | 1-10 |
| BF-C | 0 | Y | 1 |
| | 5 | N | |
| | 10 | N | |
| | 15 | N | |
| BF-HO | 0 | N | |
| | 5 | N | |
| | 10 | N | |
| | 15 | N | |
| BF-HM | 0 | N | |
| | 5 | N | |
| | 10 | N | |
| | 15 | N | |
| RF-C | 0 | N | |
| | 5 | N | |
| | 10 | N | |
| | 15 | Y | |
| RF-HO | 0 | N | |
| | 5 | N | |
| | 10 | N | |
| | 15 | N | |
| RF-HM | 0 | N | |
| | 5 | N | |
| | 10 | N | |
| | 15 | N | |

Day 90—Refrigerated

| | | | Level of |
|---|---|---|---|
| BACKING- | Time to | Cracking | Cracking |
| FILM | Unroll | Y/N | 1-10 |

| | | |
|---|---|---|
| BF-C | 0 | N |
| | 5 | N |
| | 10 | Y |
| | 15 | N |
| BF-HO | 0 | N |
| | 5 | Y |
| | 10 | N |
| | 15 | N |
| BF-HM | 0 | Y |
| | 5 | Y |
| | 10 | N |
| | 15 | N |
| RF-C | 0 | Y |
| | 5 | N |
| | 10 | Y |
| | 15 | N |
| RF-HO | 0 | N |
| | 5 | N |
| | 10 | N |
| | 15 | N |
| RF-HM | 0 | N |
| | 5 | N |
| | 10 | N |
| | 15 | N |
| SW-C | 0 | N |
| | 5 | N |
| | 10 | N |
| | 15 | N |
| SW-HM | 0 | N |
| | 5 | N |
| | 10 | N |
| | 15 | N |
| P-C | 0 | N |
| | 5 | Y |
| | 10 | N |
| | 15 | N |

Day 120—Frozen

| | | | Level of |
|---|---|---|---|
| BACKING- | Time to | Cracking | Cracking |
| FILM | Unroll | Y/N | 1-10 |
| BF-C | 0 | Y | 2 |
| | 5 | Y | 2 |
| | 10 | N | |
| | 15 | N | |
| BF-HO | 0 | N | |
| | 5 | N | |
| | 10 | N | |
| | 15 | N | |
| BF-HM | 0 | N | |
| | 5 | N | |
| | 10 | N | |
| | 15 | Y | 1 |
| RF-C | 0 | Y | 2 |
| | 5 | Y | 1 |
| | 10 | N | |
| | 15 | N | |
| RF-HO | 0 | N | |
| | 5 | N | |
| | 10 | N | |
| | 15 | N | |
| RF-HM | 0 | N | |
| | 5 | N | |
| | 10 | Y | 4 |
| | 15 | N | |
| FRU-C | 0 | N | |
| | 5 | N | |
| | 10 | N | |
| | 15 | N | |
| FRU-HM | 0 | N | |
| | 5 | N | |
| | 10 | N | |
| | 15 | N | |
| P-C | 0 | N | |
| | 5 | N | |
| | 10 | Y | 2.5 |
| | 15 | N | |

Freeze Plan—Refrigerated for 90 Days

| | | | Level of |
|---|---|---|---|
| BACKING- | Time to | Cracking | Cracking |
| FILM | Unroll | Y/N | 1-10 |
| RF-C | 0 | Y | 2 |
| | 5 | N | |
| | 10 | N | |
| | 15 | N | |
| RF-HO | 0 | Y | 8 |
| | 5 | Y | 2 |
| | 10 | N | |
| | 15 | N | |
| RF-HM | 0 | Y | 3 |
| | 5 | Y | 1 |
| | 10 | N | |
| | 15 | N | |
| SW-C | 0 | Y | 5 |
| | 5 | Y | 3 |
| | 10 | Y | 1 |
| | 15 | N | |
| SW-HM | 0 | Y | 3 |
| | 5 | Y | 3 |
| | 10 | Y | 2 |
| | 15 | Y | 1 |
| P-C | 0 | Y | 2 |
| | 5 | Y | 3 |
| | 10 | N | |
| | 15 | N | |

Results

The data show that rolled pie crusts that use rice flour as anti-sticking agents, without any other liner, were stable during refrigerated and frozen storage, so they could be unrolled after such storage without undue cracking of the crust.

1. A rolled-up dough composition comprising rice flour between contacting surfaces, the dough composition being capable of being unrolled following 30 days of refrigerated storage.

2. The dough composition of claim 1 wherein the dough composition is capable of being unrolled after 7 months of frozen storage, followed by 90 days of refrigerated storage.

3. The dough composition of claim 1 comprising 0.1 to 2 grams rice flour per gram of dough composition, wherein the dough composition is a sheet having a thickness in the range from 1/16 to ⅜ inches.

4. The composition of claim 1 comprising 0.3 to 1.5 grams rice flour per gram of dough composition, wherein the dough composition is a sheet having a thickness in the range from 1/16 to ⅜ inch.

5. The composition of claim 1 wherein the dough composition can be unrolled without tearing after 90 days of refrigerated storage.

6. The composition of claim 1 wherein the dough composition is a rolled-up circular pie crust.

7. The composition of claim 1 wherein the rice flour has an average particle diameter in the range from 25 microns to 270 microns.

8. The composition of claim 1 wherein the rice flour has an average particle diameter in the range from 50 microns to 200 microns.

9. A method of preventing contacting surfaces of a refrigerated, rolled-up dough composition from sticking together, the method comprising disposing rice flour between contacting surfaces.

10. The method of claim 9 wherein the dough composition is a rolled-up circular pie crust.

11. The method of claim 9 comprising disposing the rice flour onto only one surface of the dough composition.

12. The method of claim 9 comprising
providing a circular pie crust having a thickness in the range from 1/16 to ⅜ inch,
disposing from 0.1 to 2 grams rice flour per gram pie crust dough onto only one surface of the dough, and
rolling the pie crust into a rolled form.

13. The method of claim 9 wherein the rice flour has an average particle diameter in the range from 25 microns to 270 microns.

14. A dough product comprising a rolled-up dough composition in a package, wherein the dough composition does not contain a sheet between layers of the rolled dough.

15. The dough product of claim 14 wherein the dough composition includes rice flour between contacting surfaces.

16. The dough product of claim 14 wherein the dough composition is capable of being unrolled following 90 days of refrigerated storage.

17. The dough product of claim 14 wherein the dough product is frozen or refrigerated.

18. The dough product of claim 14 wherein the package comprises a flexible tube.

19. The dough product of claim 14 comprising flexible packaging material selected from the group consisting of a flexible polymeric material, paper, and combinations thereof.

20. A dough product comprising a refrigerator stable, rolled-up, pie crust dough composition in a flexible film package, wherein the dough composition does not contain a sheet between layers of the rolled dough.

21. The dough product of claim 20 wherein the dough composition is capable of being unrolled following 30 days of refrigerated storage.
